(19) United States
(12) Patent Application Publication
(10) Pub. No.: US 2005/0158863 A1
(43) Pub. Date: Jul. 21, 2005

(54) Maldi-matrix

(76) Inventors: Bernd Stahl, Rosbach (DE); Gunther Boehm, Echzell (DE); Marko Mank, Allerdorf/Lda (DE)

Correspondence Address: BACON & THOMAS, PLLC, 625 SLATERS LANE, FOURTH FLOOR, ALEXANDRIA, VA, 22314, US

(21) Appl. No.: 10/503,935

(22) PCT Filed: Jul. 30, 2003
(86) PCT No.: PCT/EP03/08435

(30) Foreign Application Priority Data
Aug. 19, 2002 (DE) 102-38-069.4

(51) Int. Cl. G01N 31/00

(52) U.S. Cl. 436/8

(57) ABSTRACT

Matrices for ultraviolet matrix-assisted laser desorption/ionisation mass spectrometry consisting of a salt of an amine reacting as a proton acceptor and an organic substance reacting as a proton donor, wherein either the amine or the organic substance absorbs UV light, are provided These matrices are characterised in that the matrices are in the form of an ionic liquid at room temperature, that the amine is selected from the group consisting of 3-aminoquinoline, pyridine, a primary amine, to whose N atom may be bound a phenyl residue or a linear or branched, saturated C₁-C₁₁ alkyl residue, which may be substituted with an OH group, a secondary and tertiary amine, to whose N atom may be bound two or three residues, which may be the same or different. With these liquid matrices, error-free and reproducible analytical values can be obtained, and in particular the coupling of the pure mass spectrometric analysis with the additional findings from enzymatic reactions/modifications with the possibility of monitoring is possible.

The invention concerns matrices for ultraviolet matrix-assisted laser desorption/ionisation mass spectrometry consisting of a salt of an amine reacting as a proton acceptor and an organic substance reacting as a proton donor, wherein either the amine or the organic substance absorbs UV light, and the use of such matrices.

Ultraviolet matrix-assisted laser desorption/ionisation mass spectrometry is generally abbreviated as UV-MALDI-MS.

The analytical principle of UV-MALDI-MS is based on a matrix-assisted laser desorption and ionisation of molecules including biomolecules from a cocrystallisation of an analyte and a UV light absorbing matrix substance. Such UV light absorbing substances are also referred to simply as MALDI matrix.

Common MALDI matrices are for example 2,5-dihydroxybenzoic acid (DHB), α-cyano-4-hydroxycinnamic acid (CHCA) and trans-3,5-dimethoxy-4-hydroxycinnamic acid (sinapic acid).

The cocrystallisation of analyte and matrix is for example generally effected by mixing and drying aqueous solutions of the said UV light absorbing matrix substances and the analyte on a metal sample holder. The ions created from the solid phase of the cocrystallisation are then detected with mass spectrometric analysers, which are for example based on the TOF, quadrupole, ion trap or FTICR principle or on a combination of these techniques.

UV-MALDI-MS is predominantly used for mass spectrometric analyses of molecules or of biomolecules, for example carbohydrates, proteins, peptides, nucleotides and lipids including corresponding conjugates thereof such as glycoproteins, lipoproteins, etc. The direct characterisation of whole cells and microorganisms is also possible by means of MALDI-MS analysis. Concerning this, reference is for example made to Alomirah H F , Alli I, Konishi Y., Applications of mass spectrometry to food proteins and peptides, J. Chromatogr. A. 2000 Sep. 29; 893 (1): 1-21. Review; Kussmann M, Roepstorff P. Sample preparation techniques for peptides and proteins analysed by MALDI-MS, Methods Mol. Biol. 2000; 146: 405-24; Bonk T, Humney A., MALDI-TOF MS analysis of Protein and DNA, Neuroscientist, 2001, 27 (5), 465-72.

MALDI-MS has many advantages. Among these are the high sensitivity of the analysis (femto- to attomole range for isolates), a high tolerance towards impurities and various buffer substances, simple sample preparation (“dried droplet process”) and the integration of the MALDI-MS principle into high throughput analyses.

Furthermore, it is possible to use enzymes on the MALDI targets or the MALDI sample holders, in order to make modifications to the molecules to be investigated and to detect these by mass spectrometry. For this, a solution of enzyme, analyte/substrate and a neutral, conventional MALDI matrix such as ATT is applied directly onto the MALDI target. The enzymatic reaction that takes place is then stopped by drying and cocrystallisation of the reaction mixture. The analysis of the reaction products by MALDI can then be carried out as usual after the actual enzymatic reaction. Alternatively, an acidic matrix such as for example DHB can be added to the reaction mixture later to end an enzymatic reaction.

However, a significant disadvantage of MALDI-MS analysis with a solid matrix or a solid analyte preparation is the often high variance of the signal intensities of the analyte during the desorption from different places on the same preparation or the same specimen. This variation is firstly due to the fact that the analyte molecules are differently distributed over the surface of the dried preparation. Secondly, the cause for this can be seen in the differing incorporation of different classes of substance into the crystal lattice of the dried cocrystallisation of analyte/sample and matrix. Now, various preparation procedures have already been proposed in order to achieve more homogenous crystallisations. These for example include thin layer preparation (Vorm O., Roepstorf, P., Mann M., Anal. Chem., 64, 1992, 1879-1884), preparation on thin layers of matrix crystals, which serve as crystallisation nuclei, the use of additions of nitrocellulose and also fucose and the dissolution of normal MALDI matrices such as DHB or CHCA in glycerine (Sze E T, Chan T W, Wang G. Formulation of matrix solutions for use in matrix-assisted laser desorption/ionisation of biomolecules. J. Am. Soc. Mass. Spectrom. 1998 February; 9 (2): 166-74). However, these optimised procedures always only solve problems relating to some aspects of MALDI-MS analysis.

Ionic liquids consisting of an amine salt of an organic acid have also already been proposed as matrices for MALDI-MS, see D. W. Armstrong et al., Anal. Chem. 2001, 73, 3679-3686. This relates to amine salts of various cinnamic acid derivatives or from aminoquinoline and CHCA (Kolli V S K, Orlando R, Rapid Commun. Mass Spectrom. 1996, 10: 923-926).

The purpose of the present invention is to provide improved matrices for UV-MALDI-MS, with which error-free and reproducible analytical values can be obtained, wherein in particular coupling of the pure mass spectrometric analysis with the additional findings from enzymatic reactions/modifications with the possibility of monitoring will be possible.

This purpose is achieved through the matrix according to the teaching of claims 1 to 4, and through the use of this matrix in the form of an ionic liquid according to the teaching of the use claims.

The object of the invention comprises novel matrices, namely those which are ionic liquids and hence are liquid at room temperature. These matrices are made up of a salt of an amine reacting as a proton acceptor and an organic substance reacting as a proton donor, where either the amine or the organic substance absorbs UV light. The amine is 3-aminoquinoline, pyridine, a primary amine, to whose N atom may be bound a phenyl residue or a linear or branched, saturated C₁-C₁₁ alkyl residue, which may be substituted with an OH group, a secondary or tertiary amine, to whose N atom may be bound two or three residues, which may be the same or different and which may be a linear or branched, saturated C₁-C₈ alkyl residue, which may be substituted with an OH group, and a phenyl residue, imidazole and the C- and/or N-alkylated imidazole derivatives.

The said C₁-C₈ alkyl residues can thus possess 1, 2, 3, 4, 5, 6, 7 or 8 C atoms, and the C₁-C₁₁ alkyl residues in the primary amines can possess 1, 2, 3, 4, 5, 6, 7, 8, 9, 10 or 11 C atoms.

Thus the amines used according to the invention include the following:
a primary amine, to whose N atom is bound a methyl, ethyl, n-propyl, isopropyl, n-butyl, isobutyl, n-pentyl, isopentyl, n-hexyl, isohexyl, n-heptyl, isoheptyl, n-octyl, isooctyl, n-nonyl, isononyl, n-decyl, isodecyl, n-undecyl or isoundecyl residue, which may be substituted with an OH group, or a phenyl residue.
a secondary or tertiary amine, to whose N atom are bound two or three residues, which may be the same or different and which are selected from the group consisting of methyl, ethyl, n-propyl, isopropyl, n-butyl, isobutyl, n-pentyl, isopentyl, n-hexyl, isohexyl, n-heptyl, isoheptyl, n-octyl and isooctyl residues, which may be substituted with an OH group, and a phenyl residue.
3-aminoquinoline, pyridine, imidazole and the C- and/or N-alkylated imidazole derivatives, wherein the alkyl residues may be the same or different and in particular possess 1, 2, 3, 4, 5, or 6 C atoms.

The iso residues cited above include all possible isomers.

The organic substance is 2,5-dihydroxybenzoic acid and the isomers thereof (in particular 2,6-dihydroxybenzoic acid), 2-hydroxy-5-methoxybenzoic acid and the isomers thereof, picolinic acid, 3-hydroxypicolinic acid, nicotinic acid, 5-chloro-2-mercaptobenzothiazole, 6-aza-2-thiothymine, trifluormethansulfonate, 2′,4′,6′-trihydroxyacetophenone monohydrate, 2′,6′-dihydroxyacetophenone, 9H-pyrido[3,4-b]indole, dithranol, trans-3-indoleacrylic acid, osazones, ferulic acid, 2,5-dihydroxyacetophenone, 1-nitrocarboazole, 7-amino-4-methylcoumarin, 2-(p-hydroxyphenylazo)-benzoic acid, 8-aminopyrene-2,3,4-trissulphonic acid, 2[2E-3-(4-tert-butyl-phenyl)-2-methylprop-2-enylidene]malononitrile (DCTB), 4-methoxy-3-hydroxycinnamic acid and 3,4-dihydroxycinnamic acid. As well as the isomers cited for the individual organic substances, isomers and in particular positional isomers of the other organic substances can be used, provided that they are capable of forming an ionic liquid with an amine, which is explained in still more detail below. Thus, those matrices are claimed which are present as an ionic liquid at room temperature. This ionic liquid is created on the basis of an acid-base reaction from an aforesaid amine with the function of a proton acceptor and an aforesaid organic substance with the function of a proton donor.

The amine is preferably aniline, ethanolamine, ethylamine, n-butylamine, N,N-diethylamine, N,N-diethylaniline, N,N-diethylmethylamine, N,N-dimethylamine, triethylamine, tri-n-propylamine, tri-n-butylamine, 3-aminoquinoline and pyridine.

Preferable among the novel matrices are 2,5-dihydroxybenzoic acid-butylamine and 2-hydroxy-5-methoxybenzoic acid-butylamine.

The novel matrices are obtainable by treating an amine described above, reacting as a proton acceptor, with an organic substance described above, reacting as a proton donor, in a mole ratio of 0.5:1 to 1:0.5 and preferably in equimolar ratio, for example by bringing these two reactants into contact. If only one of the reactants is liquid, then the solid reactant can be added to the liquid reactant and vice versa. In the case of two liquid reactants, these can be added together. Preferably, however, the two reactants are brought into contact with one another in a solvent, which is removed after the reaction, preferably by distilling off the solvent, in particular under vacuum. If liquid reaction products are obtained in this reaction or after the removal of the solvent, then these are ionic liquids or matrices according to the invention.

Thus it can be established directly by a simple experiment whether an ionic liquid is producible at room temperature from an amine described here, reacting as a proton acceptor and an organic substance described here, reacting as a proton donor. If this is the case, this is a matrix according to the invention.

A further object of the invention is the use of the novel matrix and of known matrices in the form of ionic liquids consisting of a salt of an amine reacting as a proton acceptor and of cinnamic acid or a cinnamic acid derivative, the amine being one to whose N atom may be bound one, two or three methyl, ethyl, n-propyl, isopropyl, n-butyl [or] isobutyl residue(s), which may be substituted by an OH group, and/or a phenyl residue, pyridine or 3-amino-quinoline, as a medium for carrying out reactions with (bio)polymers and for monitoring these reactions and for the analysis of the reaction products formed therein by means of ultraviolet matrix-assisted laser desorption/ionisation mass spectrometry.

These known liquid matrices are described in the place already cited above, namely by D. W. Armstrong et al. in Anal. Chem. 2001, 73, 3679-3686.

In the context of the present documents, the novel matrices and the known matrices are designated as matrices according to the invention.

Since the matrix according to the invention is liquid, there is homogeneous distribution of the analyte in this matrix. Hence the problems with the solid matrices described above do not arise. Thus for example no segregation of different analyte components at different points in the preparation takes place. Hence a TV-MALDI-MS with a liquid matrix can also be used for quantitative analysis purposes, which was hitherto only possible in a few exceptional cases, for example by the use of isotopically labelled internal standards.

A further advantage of the use of ionic liquids as the matrix consists in the fact that the matrix/analyte mixture does not have to be dry. This results in a time saving in the production of the preparation.

Nonetheless, it is also possible to use the matrices according to the invention or the ionic liquids according to the invention together with a solvent such as for example ethanol, isopropanol and also long-chain alcohols and acetonitrile, dimethylformamide, dimethyl sulphoxide and tetrahydrofuran, in order to reduce the viscosity of the ionic matrix and make it more manageable, for example pipettable. Further, through the use of the said solvents, the solubilisation of the analytes in the matrix can be improved.

The matrices according to the invention can be used without problems in already existing UV-MALDI mass spectrometers, which are for example equipped with N₂ lasers.

Moreover, with a liquid matrix, the analysis of a broad spectrum of molecules is possible. These include industrial polymers and biopolymers such as carbohydrates, e.g. oligo-saccharides, proteins, peptides, lipids, nucleic acids, secondary metabolites, drugs and conjugates thereof, for example glyco- and lipoconjugates and also secondary plant metabolites (e.g. flavonoids including procyanidines, etc.).

Moreover, with the matrices according to the invention it is possible to study the course and progress of reactions including kinetics, without having to stop the reaction at arbitrary points. This applies for example for reactions which are catalysed by enzymes, in particular glycosidases, proteases, nucleases, lipases or lyases. Thus in particular enzymatic cleavages of peptides/proteins by means of proteases (e.g. trypsin, chymotrypsin, pepsin, amino-peptidase, carboxpeptidase) and cleavages of carbohydrates and glycoconjugates by means of glycosidases (e.g. fucosidases, sialidases, galactosidases, hexosaminidases, pectinases, lyases) and in addition cleavages of lipids (triglycerides, phospholipids, glycolipids) and nucleic acids (DNA, RNA) can be studied. Further, synthetic reactions in the MALDI matrix by means of transferases such as for example transglycosidases can also be followed.

Analytes of high concentration can be directly prepared and measured undiluted. In addition, simultaneous detection of different analytes of low desorption point-dependent variance is possible. This also applies for analytes of different substance classes, possibly with differing physical and chemical properties.

The use of a liquid matrix also makes it possible to analyse labile analytes. Here it is assumed, without being bound to this explanation, that the desorption from a liquid matrix proceeds more gently, since the analyte passes into the gaseous phase not from the crystal lattice, but from a liquid.

Owing to the fact that the pH value of the matrix according to the invention lies closer to physiological values of non-covalent complexes and acid-labile molecules, such analytes can also be measured.

Furthermore, the liquid matrices also enable the coupling of analytical and preparative chromatographic methods such as HPLC, GPC and HPAEC with the MALDI-MS. Thus for example in the atmospheric pressure MALDI mode, the matrix and the column eluate can be mixed in or before the source. In offline MALDI analysis, suitable sample application robots can apply column eluates in parallel with liquid matrix onto targets, so as continuously to ensure improved analysis, with “portrayal” of a high chromatographic separation.

As well as with LC, ultraviolet matrix-assisted laser desorption/ionisation mass spectrometry can also be used with electrophoresis techniques (such as FFE, PAGE or CE techniques), optionally with the use of sample application robots, or combined/coupled with (micro)-preparation/separation techniques, in particular μTAS, GYROS® and Lab-on-Chip®.

A further object of the invention is a process according to the teaching of the process claims.

The invention is described below in more detail on the basis of examples illustrating preferred embodiments. In principle, the matrices according to the invention can be prepared by adding an amine reacting as a proton acceptor in equimolar proportion to an organic substance reacting as a proton donor, where either the amine or the organic substance absorbs TV light. The reaction is performed at room temperature. An ionic liquid or a liquid salt is obtained, which is generally stable to high vacuum and can be used as a UV-MALDI matrix.

### EXAMPLE 1

### Preparation of 2,5-dihydroxybenzoic Acid-butylamine (DHB-Bu):

308.4 mg of 2,5-dihydroxybenzoic acid (DHB) were dissolved in 10 ml of ethanol. Then 198.4 μl of butylamine (Bu) were added.

The solvent was distilled off at ca. 40° C. and ca. 43 mbars, until no further reduction in volume took place (ca. 30 mins). The final volume of the DHB-Bu obtained was about 200 μl.

### EXAMPLE 2

### Preparation of 5-methoxysalicylic Acid-butylamine (MSA-Bu):

336.4 mg of 5-methoxysalicylic acid (MSA; also described as 2-hydroxy-5-methoxybenzoic acid) were dissolved in 10 ml of ethanol. 198.4 μl of butylamine (Bu) were added to this. The workup was carried out as in Example 1. Ca. 200 μl of MSA-butylamine (MSA-Bu) were obtained.

By mixing butylamine-DHB with butylamine-MSA (10:1) (v/v), butylamine-DHBS can be prepared.

### EXAMPLE 3

### Preparation of α-cyano-4-hydroxycinnamic Acid-butylamine (CHCA-Bu):

378.4 mg of α-cyano-4-hydroxycinnamic acid (CHCA) were dissolved in 10 ml of methanol. Then 198.4 μl of butylamine (Bu) were added. The workup was carried out as in Example 1. 200 μl of α-cyano-4-hydroxycinnamic acid-butylamine (CHCA-Bu) were obtained.

### EXAMPLE 4

### Preparation of Sinapic Acid-triethylamine:

378.4 mg of sinapic acid (trans-3,5-dimethoxy-4-hydroxycinnamic acid) were dissolved in 10 ml of ethanol. Then 278.4 μl of triethylamine were added. The workup was carried out as in Example 1. 200 μl of sinapic acid-triethylamine were obtained.

### EXAMPLE 5

### Preparation of 6-aza-2-thiothymine-butylamine (ATT-Bu):

286.4 mg of 6-aza-2-thiothymine (ATT) were dissolved in 10 ml of ethanol. Then 198.4 μl of butylamine (Bu) were added.

The solvent was distilled off at ca. 40° C. and ca. 43 mbars, until no further reduction in volume took place (ca. 30 mins). The fmal volume of the ATT-Bu obtained was about 200 μl.

### EXAMPLE 6

### Preparation of 2′,4′,6′-trihydroxyacetophenone Monohydrate-butylamine (THAP-butylamine):

372.4 mg of 2′,4′,6′-trihydroxyacetophenone monohydra (THAP) were dissolved in 10 ml of ethanol. Then 198.4 μl of butylamine (Bu) were added.

The solvent was distilled off at ca. 40° C. and ca. 43 mbars, until no further reduction in volume took place (ca. 30 mins). The final volume of the THAP-Bu obtained was about 200 μl.

To decrease the viscosity of the ionic matrices obtained, these can in each case be diluted with a solvent, for example pure ethanol in a 1/1 v/v ratio and are then readily pipettable.

### EXAMPLE 7

The preparation of a matrix analyte preparation can be effected by the following general procedure:
1. 1 μl of liquid ionic matrix A (undiluted or 1:1 (v/v) in EtOH or solvent B) are mixed with 1 μl of analyte C in a suitable solvent D on a MALDI sample plate (stainless steel target).
2. Alternatively, the preparation can be effected as in 1., but after prior desalting of the analyte by incubation in a 1:1 (v/v) dilution with a crown ether or with ion exchangers.
3. The MALDI sample plate with the premixed sample is transferred directly into the MALDI high vacuum. Then the MALDI-MS analysis is performed.

As the matrix A, all the ionic liquids described here can be used, and in particular the following: butylamine-CHCA, butylamine-DHB, butylamine-MSA, butylamine-DHBS and triethylamine-sinapic acid.

As the solvent B, the following can be used: acetone, acetonitrile, methanol (MetOH), ethanol (EtOH), butanol, isopropanol, chloroform and H₂O.

The analyte C can be from the following substance classes:
1. industrial polymers (e.g. PEG, polyacrylamide, PE),
2. carbohydrates (e.g. mono-, di-, tri-, oligo- and polysaccharides of homopolymeric and heteropolymeric composition),
3. proteins and peptides,
4. lipids,
5. conjugates of the above analytes,
6. mono-, di-, tri-, oligo- and polynucleotides,
7. secondary plant metabolites (phenolic substances, flavonoids, etc.),
8. atoms which are not volatile in high vacuum, (e.g. alkali and alkaline earth metals (such as Na, K, Ca, Mg), metals (such as Fe, Zn, Sn, Cu, Cr, etc.).

As the solvent D, the following can be used:

Aqueous or acidified solution of 10-80% MetOH, EtOH, H₂O, acetone, acetonitrile, isopropanol, butanol, chloroform, DMSO, DMF, glycerine and THF.

The solution can be acidified e.g. with 0.1-5% TFA, acetic acid or formic acid.

### EXAMPLE 8

### Preparation of 2,6-dihydroxybenzoic Acid-butylamine (2,6-DHB-Bu):

308.4 mg of 2,6-dihydroxybenzoic acid (DHB) were dissolved in 10 ml of ethanol. Then 198.4 μl of butylamine (Bu) were added.

The solvent was distilled off at ca. 40° C. and ca. 43 mbars, until no further reduction in volume took place (ca. 30 mins). The final volume of the 2,6-DHB-Bu obtained was about 200 μl.

### EXAMPLE 9

### Preparation of 2,5-dihydroxybenzoic Acid-1-hexyl-3-methylimidazole (DHB-HMIM).

308.4 mg of 2,5-dihydroxybenzoic acid (DHB) were dissolved in 10 ml of ethanol. Then 371.4 mg of 1-hexyl-3-methylimidazole (HMIM) were added.

The solvent was distilled off at ca. 40° C. and ca. 43 mbars, until no further reduction in volume took place (ca. 30 mins). The final volume of the DHB-HMIM obtained was about 200 μl.

### EXAMPLE 10

### Preparation of 3-aminoquinoline Triflate (AC-triflate):

288.4 mg of 3-aminoquinoline (AC) were dissolved in 10 ml of ethanol. Then 298.2 mg of trifluoromethanesulphonate were added.

The solvent was distilled off at ca. 40° C. and ca. 43 mbars, until no further reduction in volume took place (ca. 30 mins). The final volume of the 3-aminoquinoline triflate obtained was about 200 μl.

In this matrix, the 3-aminoquinoline and thus the amine or proton acceptor is the compound which is capable of absorbing UV light, while in the other examples the amine is not capable of this, but the organic substance functioning as proton donor absorbs the UV light.

### EXAMPLE 11

In the matrices described above, reactions of (bio)polymers and in particular enzymatic reactions can be carried out. In these, the matrix also serves as the medium or “reaction container”. The course of the reactions can then be followed directly and continuously by mass spectrometry.

For the production of the corresponding preparations the following procedure can be used (general procedure):

0.5 μl of liquid matrix A (undiluted or 1:1 (v/v) in EtOH or another suitable solvent) are homogeneously mixed with 0.5 μl of an enzyme B (ca. 1 μg/μl) in a suitable solvent/buffer C and with 0.5 μl of a substrate D (ca. 1 μg/μl) in a suitable solvent/buffer on a MALDI sample plate. After this, the MALDI sample plate with the premixed enzymatic reaction mixture in the ionic liquid MALDI matrix is transferred directly into the MALDI high vacuum.

As the matrix A, those cited in example 7 can be used.

As the enzyme B, the following enzyme classes can be used: hydrolases, isomerases, lyases, transferases, oxidoreductases and ligases.

As the solvent/buffer C, the following can be used: H₂O, carbonate buffer, ammonium acetate buffer, Tris buffer or another suitable and MS-compatible buffer system or solvent.

The enzyme/substrate ratio in the finished matrix-enzyme-substrate solution here is 1:1 to 1:300 (w/w) or more.

### USE EXAMPLES

Desialisation of a trisaccharide from human milk: mix 0.5 μl of sialidase from Clostridium Perfringens 1 μg/μl (ca. 0.1 U/μl) in 25 mM NH₄ acetate buffer at pH 5.0) with 0.5 μl sialyllactose 1 μg/μl in H₂O and with 0.5 μl DHB-Bu (1:1 in EtOH) on a MALDI sample plate and transfer directly into the MALDI-MS high vacuum.
Defucosylation of a pentasaccharide from human milk: mix 0.5 μl of α-fucosidase from bovine kidneys 1 μg/μl (ca. 2 mU/μl) in 25 mM NH₄ acetate buffer at pH 5.0) with 0.5 μl LNFP 1 μg/μl in H₂O and with 0.5 μl DHB-Bu (1:1 in EtOH) on a MALDI sample plate and transfer directly into the MALDI-MS high vacuum.
Deglycosylation of a glycoprotein: mix 0.5 μl of PNGase F from Flavobacterium Meningosepticum, recombinant 1 μg/μl (ca. 0.5 U/μl) in 20 mM Tris buffer pH 7.5 with 0.5 μl RNAse B 1 μg/μl in H₂O and with 1 μl CHCA-Bu or DHB-Bu (1:1 in EtOH) on a MALDI sample plate and transfer directly into the MALDI-MS high vacuum.
Enzymatic hydrolysis of human casein: mix 0.5 μl of trypsin with TPCK from bovine pancreas 0.01-1 μg/μl (ca. 0.074-7.4 U/μl) with 0.5 μl β-casein 1 μg/μl in imidazole buffer 12.5 mM pH 7.6 and with 1 μl CHCA-Bu (1:1 in EtOH) on a MALDI sample plate and transfer directly into the MALDI-MS high vacuum.
Carboxypeptidase digestion for the sequence analysis of a peptide: mix 0.5 μl of carboxypeptidase from Saccharomyces Cerevisiae (CPY) 0.2 μg/μl (ca. 20 mU/μl) with 0.5 μl peptide 0.1-1 μg/μl in 60 mM diammonium hydrogen citrate buffer pH 5 and with 1 μl CHCA-Bu (1:1 in EtOH) on a MALDI sample plate and transfer directly into the MALDI-MS high vacuum.
Aminopeptidase digestion for the sequence analysis of a peptide: mix 0.5 μl of aminopeptidase from Aeromonas Protolytica 0.2 μg/μl (ca. 20 mU/μl) with 0.5 μl peptide 0.1-1 μg/μl in tricine buffer pH 8+ZnCl₂ and with 1 μl CHCA-Bu (1:1 in EtOH) on a MALDI sample plate and transfer directly into the MALDI-MS high vacuum.
Dephosphorylation of a phosphoglycopeptide: mix 0.5 μl of acid phosphatase from potatoes 0.01-1 μg/μl (ca. 0.02-2 U/μl) with 0.5 μl β-casein 1 μg/μl in 25 mM NH₄ acetate buffer at pH 5 and with 1 μl CHCA-Bu (1:1 in EtOH) on a MALDI sample plate and transfer directly into the MALDI-MS high vacuum.
Dephosphorylation of a phospholipid: mix 0.5 μl of phospholipase A₂ from honeybee venom 0.01 μg/μl (ca. 10 mU/μl) with phosphatidylcholine dihepta-decanoyl 1 μg/μl in MetOH/CHCl₃ (2:1) and with 1 μl DHB-Bu (1:1 in EtOH) on a MALDI sample plate and transfer directly into the MALDI-MS high vacuum.
Deglycosylation of a glycolipid/ganglioside: mix 0.5 μl of ceramide glycanase from Marobdella Decora 1 μg/μl (ca. 10 mU/μl) in 20 mM Tris buffer pH 7.0 with bovine ganglioside GM1 1 μg/μl in H₂O and with 1 μl CHCA-Bu or DHB-Bu (1:1 in EtOH) on a MALDI sample plate and transfer directly into the MALDI-MS high vacuum.
Sequencing of an oligonucleotide: mix 0.5 μl of phosphodiesterase I from Crotalus Adamanteus toxin ca. 1 mU/μl in 20 mM Tris buffer pH 8.0 with 0.5 μl of oligonucleotide in H₂O 1 μg/μl and with 1 μl CHCA-Bu (1:1 in EtOH) on a MALDI sample plate and transfer directly into the MALDI-MS high vacuum.

The MALDI-MS spectra are recorded for example after 0, 5, 10, 20, 30, 60 and 120 minutes. The MS analysis can, if necessary, also be extended to several days after preparation of the mixture.

In the manner described above, for example a simple screening of substrates or reaction products is also possible. Thus for example several hundred different substrates are incubated with one enzyme on only one sample plate. For this only the smallest quantities of enzyme and substrate (0.5 μl at for example 1 μl/μl) are necessary. By means of the mass spectrometric analysis, for example kinetics can be followed in vacuo. With the exploitation of already existing automatic measurement programmes, this application has a very high potential for automation and cost saving.

This for example applies in the case of the use of sialidase for the disialisation of sialyllactose in DHB-Bu and in the case of the use of PNGaseF for the deglycosylation of glycopeptides/glycoproteins in DHB-Bu.

Furthermore, the matrices described above can be used in combined LC-MALDI-MS or in electrophoresis-MALDI-MS procedures (PAGE, CE, FFE). Also possible is a combination with (micro)preparation/separation techniques, in particular μTAS, GYROS® and Lab-on-Chip®.

1. Matrices for ultraviolet matrix-assisted laser desorption/ionisation mass spectrometry made up of a salt of an amine reacting as a proton acceptor and an organic substance reacting as a proton donor, where either the amine or the organic substance absorbs UV light, characterised in that the matrices are in the form of an ionic liquid at room temperature, the amine is selected from the group consisting of 3-aminoquinoline, pyridine, a primary amine, to whose N atom may be bound a phenyl residue or a linear or branched, saturated C₁-C₁₁ alkyl residue, which may be substituted with an OH group, a secondary and tertiary amine, to whose N atom may be bound two or three residues, which may be the same or different and which may be a linear or branched, saturated C₁-C₈ alkyl residue, which may be substituted with an OH group, and a phenyl residue imidazole and the C- and/or N-alkylated imidazole derivatives and the organic substance is selected from the group consisting of 2,5-dihydroxy-benzoic acid and the isomers thereof, 2-hydroxy-5-methoxybenzoic acid and the isomers thereof, picolinic acid, 3-hydroxypicolinic acid, nicotinic acid, 5-chloro-2-mercaptobenzothiazole, 6-aza-2-thiothymine, 2′,4′,6′-trihydroxyacetophenone monohydrate, 2′,6′-dihydroxyacetophenone, 9H-pryido[3,4-b]indole, dithranol, trans-3-indoleacrylic acid, osazones, ferulic acid, 2,5-dihydroxyacetophenone, 1-nitrocarboazole, 7-amino-4-methylcoumarin, 2-(p-hydroxyphenylazo)-benzoic acid, 8-aminopyrene-2,3,4-trissulphonic acid, 2[2E-3-(4-tert-butylphenyl)-2-methylprop-2-enylidene]malononitrile (DCTB), 4-methoxy-3-hydroxycinnamic acid, trifuloromethanesulphonate and 3,4-dihydroxycinnamic acid.

2. Matrix according to claim 1, characterised in that the amine is aniline, ethanolamine, ethylamine, n-butylamine, N,N-diethylamine, N,N-diethylaniline, N,N-diethylmethylamine, N,N-dimethylamine triethylamine, tri-n-propylamine, tri-n-butylamine, 3-aminoquinoline and pyridine.

3. Matrices according to claim 1, characterised in that the matrices are 2,5-dihydroxybenzoic acid-butylamine or 2-hydroxy-5-methoxybenzoic acid-butylamine.

4. Matrices according to claim 1, characterised in that they are treated with a solvent.

5. Method of use of the matrices taking the form of ionic liquids according to claim 1 in ultraviolet matrix-assisted laser desorption/ionisation mass spectrometry and in particular for quantitative ultraviolet matrix-assisted laser desorption/ionisation mass spectrometry.

6. Method of use of the matrices taking the form of ionic liquids according to claim 1 and of matrices taking the form of ionic liquids liquid at room temperature consisting of a salt of an amine reacting as a proton acceptor and of cinnamic acid or a cinnamic acid derivative, the amine being one to whose N atom may be bound one, two or three methyl, ethyl, n-propyl, isopropyl, n-butyl isobutyl residue(s), which may be substituted by an OH group, and/or a phenyl residue, 3-aminoquinoline or pyridine, as a medium for carrying out reactions with (bio)polymers and for monitoring these reactions and for the analysis of the reaction products formed therein by means of ultraviolet matrix-assisted laser desorption/ionisation mass spectrometry.

7. Method of use according to claim 6, characterised in that the reactions are catalysed by enzymes, in particular by glycosidases, proteases, nucleases, lipases or lyases, and the (bio)polymers are peptides, proteins, carbohydrates, lipids, nucleic acids, secondary metabolites and/or drugs and conjugates thereof.

8. Method of use according to claim 5, characterised in that the ultraviolet matrix-assisted laser desorption/ionisation mass spectrometry is combined with analytical or preparative liquid chromatography, in particular HPLC, GPC and HPAEC, electrophoresis techniques, in particular CE, CEC, PAGE and FFE, or (micro)preparation/separation techniques, in particular μTAS, GYROS®) and Lab-on-Chip®.

9. Process for performing reactions with (bio)polymers and for monitoring these reactions and for the analysis of the reaction products formed therein, wherein these reactions are catalysed in particular by enzymes, preferably glycosidases, proteases, nucleases, lipases or lyases, characterised in that these reactions are performed in a matrix taking the form of an ionic liquid according to claim 1 or in a matrix taking the form of an ionic liquid consisting of a salt of an amine reacting as a proton acceptor and of cinnamic acid or a cinnamic acid derivative the amine being one to whose N atom may be bound one, two or three methyl, ethyl, n-propyl, isopropyl, n-butyl isobutyl residue(s), which may be substitutd by an OH group, and/or a phenyl residue, 3-aminoquinoline or pyridine, and monitored by means of ultraviolet matrix-assisted laser desorption/ionisation mass spectrometry.

10. Process according to claim 9, characterised in that the ultraviolet matrix-assisted laser desorption/ionisation mass spectrometry is combined with analytical or preparative liquid chromatography, in particular HPLC, GPC and HPAEC, electrophoresis techniques, in particular CE, CEC, PAGE and FFE, or (micro)preparation/separation techniques, in particular μTAS, GYROS® and Lab-on-Chip®.
